(19) United States
(12) Patent Application Publication
(10) Pub. No.: US 2013/0132352 A1
(43) Pub. Date: May 23, 2013

(54) EFFICIENT FINE-GRAINED AUDITING FOR COMPLEX DATABASE QUERIES

(71) Applicants: Shriraghav Kaushik, Bellevue, WA (US); Ravishankar Ramamurthy, Redmond, WA (US); Yupeng Fu, La Jolla, CA (US)

(72) Inventors: Shriraghav Kaushik, Bellevue, WA (US); Ravishankar Ramamurthy, Redmond, WA (US); Yupeng Fu, La Jolla, CA (US)

(73) Assignee: Microsoft Corporation, Redmond, WA (US)

(21) Appl. No.: 13/303,154

(22) Filed: Nov. 23, 2011

(51) Int. Cl. G06F 17/30; G06F 7/00

(52) U.S. Cl. 707/693; 707/736; 707/754; 707/E17.014; 707/E17.059; 707/E17.005

(57) ABSTRACT

The present application provides for techniques for implementing data auditing embodiments that determine whether a query into a database is or has referenced forbidden data within the database. Various techniques are given for efficiently finding all tuples in a database referenced by a given query. A set of sensitive data is determined within a database and the set of sensitive data is employed to define a forbidden view within the database. Data within the database may be annotated to provide efficient identification of data access by query. Incoming queries may be analyzed and modified to propagate annotations for analyzing what data is or was accessed.

### BACKGROUND

Database systems are used today as the primary repository of the most valuable information in any organization. As the volume of data stored in these repositories has increased, protecting the security of the data has gained increasing importance deepened by legislation, such as the Health Insurance Portability and Accountability Act (HIPAA).

One of the components of the DBMS security infrastructure is an auditing system that can be used a posteriori to investigate potential security breaches. Accordingly, there has been an increase in database auditing products on the market from the major database vendors. As the database system is in production, these products monitor various operations such as user logins, queries, data updates and DDL statements—to obtain an audit trail. The audit trail is analyzed offline either periodically or when needed to answer questions about access to schema objects such as: (1) find failed login attempts; and (2) find queries and corresponding users that accessed columns corresponding to Personal Identifier Information (PII).

One class of auditing is “data auditing”—i.e., auditing that correlates the audit trail with the data in the database. Examples of commercial systems that support data auditing are Microsoft Amalga® system, Microsoft HealthVault® system. Laws such as HIPAA require support for data auditing. Data auditing has been used to identify all query and update statements that “referenced” sensitive information.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

Some embodiments of the present application provide for techniques for implementing data auditing. In one embodiment, data auditing determines whether a query into a database is or has referenced forbidden data within the database. A set of sensitive data is determined within a database and the set of sensitive data is employed to define a forbidden view within the database. Data within the database may be annotated to provide efficient identification of data access by query. Incoming queries may be analyzed and modified to propagate annotations for analyzing what data is or was accessed.

In other embodiments, a method for evaluating queries into a database is disclosed. The database may comprise a forbidden view and annotated data, where the annotated data further comprises annotations based upon a world set induced by said forbidden view. The method comprises: identifying an incoming query into the database; breaking down the incoming query into a set of operators; modifying each operator to operate on the annotated data; and producing a resulting annotation from each of the modified operators.

In other embodiments, a method for auditing queries is disclosed. This embodiment comprises the steps of identifying a set of sensitive data within a database; for each sensitive data, determining an annotation, where the annotation may represent a set of worlds to which said sensitive data belongs; determining if a query references the set of sensitive data by referencing the annotations propagated by the query; and reporting a query that references the set of sensitive data.

Other features and aspects of the present system are presented below in the Detailed Description when read in connection with the drawings presented within this application.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 shows one embodiment of a DBMS block diagram comprising an auditing module.

FIG. 2A shows one example of creating a forbidden view of a database.

FIG. 2B shows one example of creating a tuple annotation of a forbidden view.

FIG. 3 shows one example of a filter operation on an annotated set of database entries.

FIG. 4 shows one example of a self-join operation on an annotated set of database entries.

FIG. 5 shows one example of a groupby operation on an annotated set of database entries that form an annotated table and the results of which are folded back into an annotated table form.

FIG. 6 shows one example of a groupby operation on an annotated set of database entries with use of an union operation.

FIG. 7 illustrates the use of the union operation performed on a set of compressed annotations.

FIG. 8 illustrates the computing the results of a groupby operation using vector operations.

FIG. 9 is one embodiment of a system that comprises query plan parser module, forbidden view world creation module and a query execution module.

FIG. 10 shows one embodiment of an auditing tool of the present application.

### DETAILED DESCRIPTION

As utilized herein, terms “component,” “system,” “interface,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

### INTRODUCTION

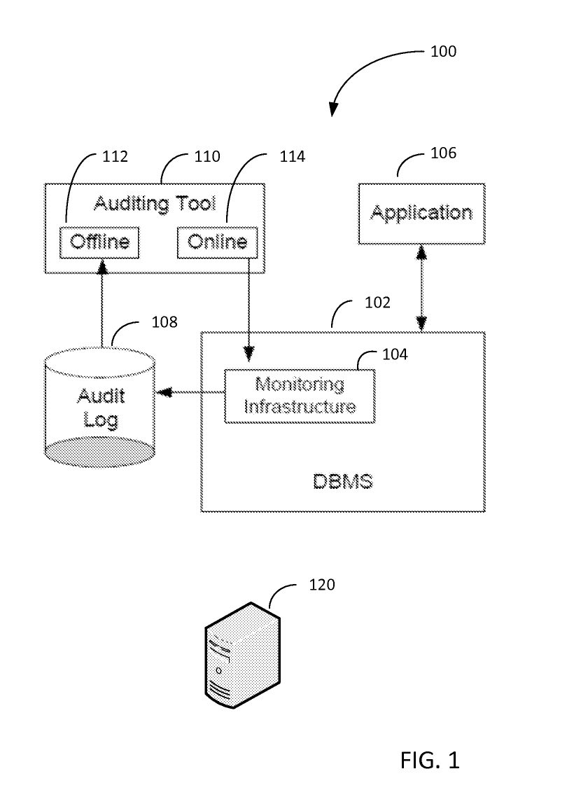

Commercial database systems provide support to maintain an audit trail that can be analyzed offline to identify potential threats to data security. FIG. 1 shows one embodiment of a system 100 comprising a database management system (DBMS) 102 that may further comprise (or, alternatively, interface with) an auditing tool 110 and audit log 108. For purposes of this application, DBMS 102 may be construed broadly and engages in all of the features and functionality that are typical for DBMS. As with most systems that perform database auditing, auditing tool 110 may comprise two components—an online component 114 and an offline component 112, as shown in FIG. 1.

Online component 114 may be used in production to log the query and update statements issued to DBMS 102 by various applications 106. This may be implemented using monitoring infrastructure 104 which is typically supported by all commercial database systems. Along with each query/update statement, it is also possible to log the corresponding User ID. User IDs may take various formats—such as a DBMS user id or, alternatively, an application user id. The sequence of query and update statements with associated user ids is known as the “workload” of the database system.

The workload may be logged in a separate secure database—for example, audit log 108. Audit log 108 may be used to perform auditing in the offline component. In general, auditing may be performed not only against the current database state but also over past database states. Accordingly, it may be desirable that the auditing component be able to reconstruct past database states. It is possible to use a “point-in-time” recovery API provided by commercial database systems that allows the system to rewind the database state to any point in the past using the database transaction log.

Computer 120 is shown in FIG. 1 to illustrate that all of the executable components (e.g. computer readable programs and/or software running on processors, microprocessors or the like) and/or computer-readable storage elements (e.g., RAM, ROM, computer-readable memory, CDs, DVDs, floppy disks, disk drives or the like) may be contained in a single computer, e.g., 120. However, in other embodiments, it is possible to have subsets of the various components implemented in a single computer 109, and the other components implemented in other computers (not shown) and working cooperatively. For example, if it is desired to implement the present auditing tool as a stand-alone system, it is possible to have auditing tool 110 and/or audit log implemented in, for example, computer 120 and have application 106 and/or DBMS 102 running on separate computer systems—while working cooperatively (possibly, in a networked fashion over intranets, the Internet or the like) with the auditing tool executing on computer 120.

In the context of database systems, such as shown in FIG. 1, it will now be disclosed techniques, systems and/or methods that may perform data auditing that asks for an audit trail of all users and queries that referenced sensitive data. One example of such a query might be: “find all queries and corresponding users that referenced John Does record in the last week”. In one embodiment of this application, a technique will be described that—when given (1) an instance of the database, (2) a query and (3) a view specifying the sensitive subset of the database, finds the sensitive rows that are “referenced” by the query. In this embodiment, a query “references” a row if deleting the row from the database changes its result.

One brute force technique to answer such query might be to formulate an algorithm that iterates over the rows in the view and for each row, finds whether the query references it by rewriting the query to exclude it. However, such an approach may be prohibitively expensive. Accordingly, the various embodiments of the techniques described herein disclose efficient techniques for solving the above query. In one embodiment, it is possible to add annotations to each row in the database and perform query execution in a manner that propagates the annotations. Thus in one modified query execution, a DBMS system would be able to find all referenced rows.

Data auditing semantics concerns itself with what it means for a query to have referenced a particular tuple (for example, single-tuple auditing). One approach is to adopt the notion of “query differentials” which is applicable to arbitrary SQL queries. The following example illustrates the notion of query differentials (see Section 2 for a formal discussion).

### A First Example

For the purposes of illustration of query differentials, consider the following example from a hypothetical health care database that has a Patients table and a Disease(PatientID, Disease) table. Consider the query Q:

select Name, Age, Zip
from Patients P, Disease D
where P.PatientID = D.PatientID
and D.Disease = ‘cancer’

Suppose it is desired to check if the above query referenced the record of a patient named Alice, the differential of the above query with respect to the record would be the corresponding rewritten version (Q′) of the above query that excludes the patient Alice as shown below.

```
select Name, Age, Zip
from Patients P, Disease D
where P.PatientID = D.PatientID
    and D.Disease = ‘cancer’
    and P.Name <> ’Alice’
```

If the result of the queries Q′ and Q are different, then query Q is defined to have accessed patient Alice's record. It should be appreciated that checking if the query differential is equivalent to the query may require the execution of both the original and the rewritten query.

Forbidden Views

In general, sensitive information within a database may be specified in the form of a view, referred to as a “forbidden view”. For example, in the health care database example, it could be possible to write a view that represents the health record of a single individual, as discussed further herein. Then, as will be described, embodiments of data auditing tools may return all queries that reference the individual's record. It should be appreciated that the view does not have to be restricted to a single individual. For example, it could define a view that represents the health records of all patients suffering from a particular disease condition, such as AIDS.

For example, consider a forbidden view that represents a large number of records. Further, suppose that it is deemed that the health records of all patients to be sensitive. Then, any query over the patients table is accessing sensitive information. Based on such scenarios, it may be desirable to consider more “fine-grained” auditing—that is, to be able to retrieve the sensitive information of which individuals was referenced by a given query (or update) statement. Having the ability to perform such fine-grained auditing may be desired and may affect more sophisticated data auditing. For merely a couple of examples, it may be possible to answer queries like: (1) find “important” customers (defined using appropriate filters on the data) that were referenced by queries issued by a particular analyst, and (2) find queries that reference the account balance of at least three “important” customers.

For purposes of illustration, consider a query Q and a forbidden view V that represents a large number of individuals. It is possible to answer the above query by iterating over all individuals in V and using query differentials to check if the query Q accessed that particular individual. However, as previously mentioned, such an iteration (which is similar to a cross-product operator) may be prohibitively expensive if the number of individuals in the database is large. Thus, it may be desirable to develop efficient techniques that enables fine-grained auditing at large-scale.

In one embodiment, an auditing tool would try to avoid this cross-product effect—by computing the query differentials corresponding to all individuals in a “single-pass”. It should be appreciated that such an auditing tool—while able to engage in multi-query optimizations—would be broader in scope than conventional multi-query optimizations. For example, the present embodiments would seek to optimize the execution of a single query on “similar” datasets—where multi-query optimization tends to involve techniques to the optimize execution of “similar” queries over the same dataset. In addition, the present embodiments would be able to handle different scales of operation. For example, while multi-query optimization techniques are typically invoked over hundreds of queries, the present embodiments would in addition, be applicable for a much larger scale—e.g., a forbidden view that represents customer information could represent millions of customers.

One Example of Forbidden View

For one embodiment, forbidden views specify sensitive information in the form of a view that may be single-table views of the form

select * from T where <predicate>.

To illustrate by way of example, consider a health care database with a table Patients(PatientID, Name, Age, Zip). Suppose further that it is desired to specify that the personal information pertaining to all children is considered sensitive. This may be accomplished by specifying the following view.

select * from Patients where Age <18

It may also be desired to support a limited class of joins as forbidden views since sensitive data can span more than one table. This will be discussed in greater detail below.

Query Differentials

Data auditing semantics defines what it means for a query to have referenced a particular tuple (that is, single-tuple auditing). It is possible to supply such a definition based on the concept of query differentials.

Given a database instance D, a query Q and a tuple t specified by the value v of its primary key, the “differential of query Q” (denoted Q) may be defined as Q rewritten to exclude tuple t from T (by adding the predicate T.id≠v). A query may be defined to “reference” tuple t if Q(D)≠Q(D). If Q(D)=Q(D), then it may be said that Q is “safe” with respect to t.

For merely one example, consider the health care database discussed above. Suppose that in addition to the Patients table, there is also a table Disease(PatientID, Disease). Consider the query:

select Name, Age, Zip
from Patients P, Disease D
where P.PatientID = D.PatientID
and D.Disease = ‘cancer’

Suppose further that there is a patient named Alice who is suffering from cancer and whose age is less than 18. Then, the above query references the tuple corresponding to Alice—removing this tuple changes the query result.

References Operator

In one embodiment, it is possible to define a new operator, “References” operator, that may provide a more efficient technique for answering such queries as follows: given a query Q and a forbidden view V, the References operator returns all tuples t such that: (1) t is in the output of V; and (2) Q references t. Thus, in continued reference to the example above, the References operator would return all patients less than age 18 that suffer from cancer.

In one embodiment, the References operator may be implemented as follows: (1) iterate over all the tuples in the forbidden view and (2) for each, compute the differential, while computing Q(D) only once. In other embodiments, it may be possible to improve on this particular implementation, as this implementation may be expensive when the number of tuples in the forbidden view is large—e.g. suppose that in the examples above, the forbidden view is “select * from Patients”; then, the number of differential queries executed is the total number of patients.

Overview of References Operator

Implementation

As noted above, it is possible to implement a system with an incremental view maintenance approach—i.e., to check for each tuple in the forbidden view as to whether deleting it from the database would change the query result. However, techniques based on view maintenance may be more appropriate for queries that are covered in the class of incrementally maintainable views. While this may include select-project-join queries with simple grouping and aggregation, there may be no simple extension to more complex queries—such as the ones in the TPCH benchmark that also include subqueries and negation. In other embodiments, it may be desirable to develop techniques that uniformly apply—not only to simple queries—but also complex queries.

To produce such other embodiments, one general approach may be as follows: deleting any single tuple t of the forbidden view from the database may define a corresponding subset of the database (denoted above by D−t). It should be noted that the original database D is trivially a subset of itself. In addition, it is possible to define each of the above subsets as a “world”.

For merely one example, consider a sales database and a forbidden view defined as follows:

```
Create Forbidden View PremiumCustomers as
    Select * From Customer Where C_Acctbal > 100k
    Partition By C_Custkey
```

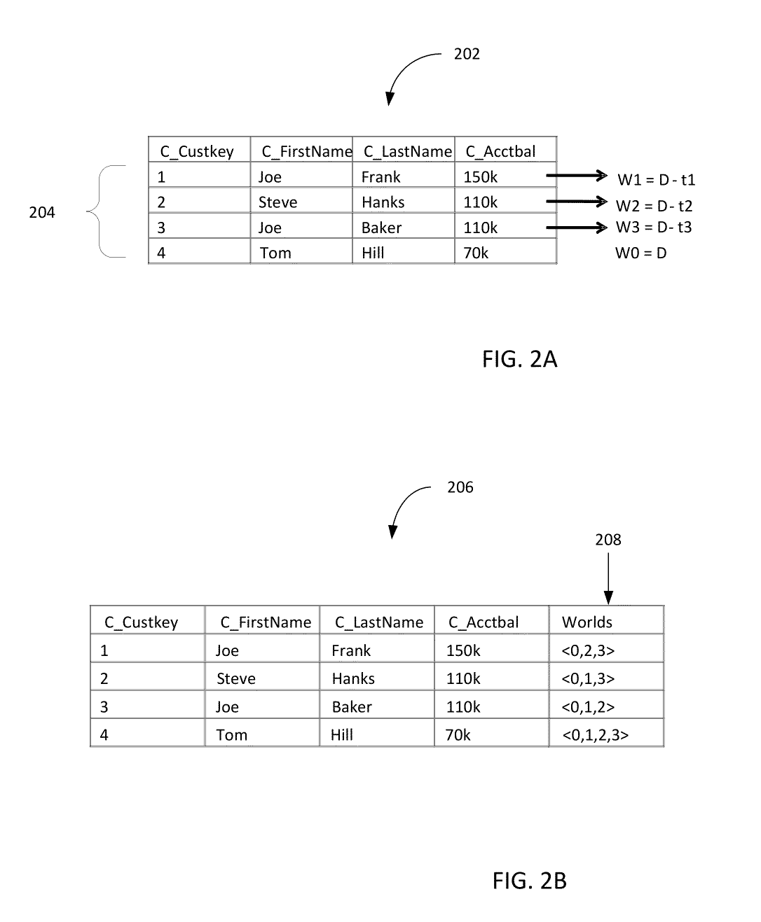

FIG. 2A illustrates the creating a forbidden view in the above example. FIG. 2A shows an instance 202 of the Customer table along with the associated worlds. Three (i.e. “Joe Frank”, “Steve Hanks”, and “Joe Baker”) of the four tuples 204 belong to the forbidden view and there is one world corresponding to each. There is also designated a world (denoted “W0” in FIG. 2A), corresponding to the full table containing all tuples. Given a query Q, it is possible to break down the overall operation of the References operator into two parts:

(1) Query Evaluation on Multiple “Worlds”—where it is possible to compute the results of Q on each of the worlds; and

(2) Result Computation—where it is possible to use the results to find the referenced tuples.

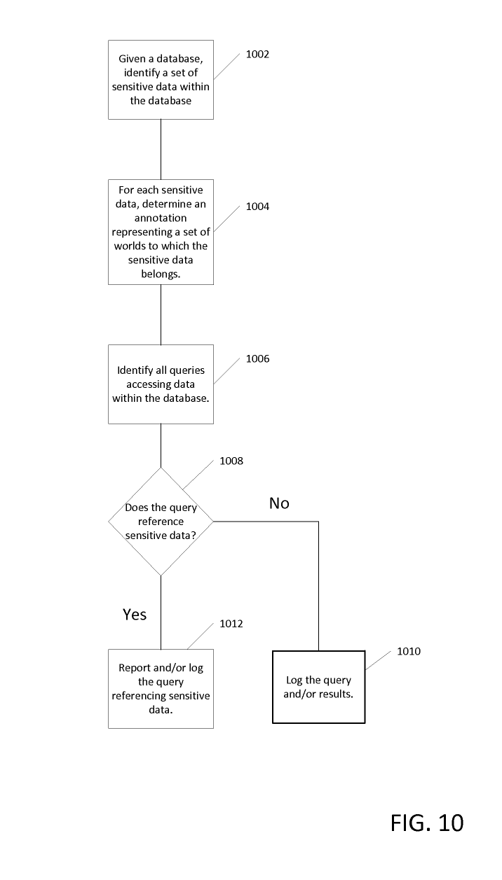

FIG. 10 shows one embodiment of an auditing tool that implements the above techniques. At step 1002, sensitive data within a given database is identified and, at 1004, an annotation (as discussed further herein) is associated with each sensitive data. In one embodiment of annotations, an annotation may be implemented as a field (or any suitable data structure) which is added to the tuples of the database entries. In addition, annotations may designate the set of worlds that are associated with each sensitive data.

As queries are presented to the database, the auditing tool takes note (or otherwise identifies) of all such queries at 1006. The auditing tool then notes whether any given query references sensitive data at 1008. This answer to this inquiry may be based upon whether the query propagates any annotations that are associated with the sensitive data, as discussed further herein. If the query does access such sensitive data, then the auditing tool may engage in a reporting (or alternatively, alerting) step at 1012 to note such reference. Otherwise, the auditing tool may optionally log the query and any desired results or information regarding the query at 1010.

It will be appreciated that these steps may be taken out of temporal order in some implementations and the present application encompasses the scope of such different implementations. For example, the identification of sensitive data and/or the determining of annotations may be performed in real-time as queries attempt to access the database. It may also be appreciated that various portions of the system and/or methods of FIG. 10 may be hosted or otherwise executed on a single computer and/or processor—or, alternatively, may be hosted or otherwise executed among various processors and working cooperatively.

Query Evaluation Algorithm

Merely for purposes of exposition in the present application, a “world set” comprises a set of databases. Each individual database may be called a “world”. The case when the database has a single table is called a “table-set”.

Now in continued reference to FIG. 2A, consider the following example. The set of databases W0, . . . , W3 is a world-set. The output of a query Q on a world-set {W0, . . . , Wn} is the set of databases {Q(W0), . . . , Q(Wn)}. Given a database D, the world set induced by a forbidden view V is the set of databases {D−t: tεV}∪{D}. It may be desired to consider the following query evaluation problem—to compute the result of query Q on the world-set induced by a forbidden view.

For the purposes of analysis, it is possible to consider space and time efficiency. For space consumption, it is possible to count the space occupied by each cell in a given table as constant. One possible implementation implied by the problem statement might be to iterate over the worlds and evaluate the query on each world. Since the number of worlds can be potentially large, this implementation may be improved upon from the standpoint of space and time expense. It may be desirable to compute the result efficiently by sharing computation. In order to improve the efficiency of query evaluation, in one embodiment, a representation of a world set may be given that may lead to such efficiencies.

Tuple Annotation

The set of worlds to which a tuple belongs is called its “annotation”. FIG. 2B is an example of tuple annotation, as it relates to the example of FIG. 2A. It is possible to represent a world set 206 by storing for each tuple, the set of worlds (208) to which it belongs. The annotation of tuple t is denoted t.Worlds.

FIG. 2A shows the annotations corresponding to the Customer table. The annotations are shown in the Worlds column 208.

For the purpose of analyzing space consumption, it is possible to count the size of each entry in the annotation set as a constant. Therefore, the size of the annotation may be counted as the number of entries.

Annotation Compression

Since the set of worlds to which a tuple belongs may be large, it is possible to compress the annotation. In one embodiment, it is possible to use run-length encoding to compress the annotations.

For example, consider the annotations in FIG. 2B. Since there are four worlds under consideration, all annotations may be thought of as Boolean vectors in 4 dimensions. For instance, the annotation {0, 2, 3} corresponding to the tuple with customer key 1 corresponds to the vector <1, 0, 1, 1>. In one embodiment, the vector may be compressed using run-length encoding to obtain the following sequence of runs: {<1, 1>, <0, 1>, <1, 2>}. Each run has two parts—a bit representing the Boolean value and the run length.

For annotations induced by a forbidden view, run-length encoding may improve the space consumed by the annotations. Consider a forbidden view with n tuples. Each tuple is present in all except one world. The vector representation of the annotation has the form <1 . . . 101 . . . 1>. Thus, after run-length compression, the number of runs in the annotation is 3 even though the original set has n−1 elements.

Query Evaluation

It will now be described the query evaluation algorithm. For the purpose of this discussion, one embodiment of compressing an uncompressed annotations will be described. It is possible to break down an SQL query into a tree of operators—e.g., filter, project, cross product, joins, groupby-aggregation, set difference and top-k. The above operators may suffice to yield a rich class of queries including the TPCH benchmark queries. Every operator consumes one or more tables as input and produces a table as output. It is possible to modify each operator to consume a world-set represented through tuple annotations and produce a result world-set also represented using annotations.

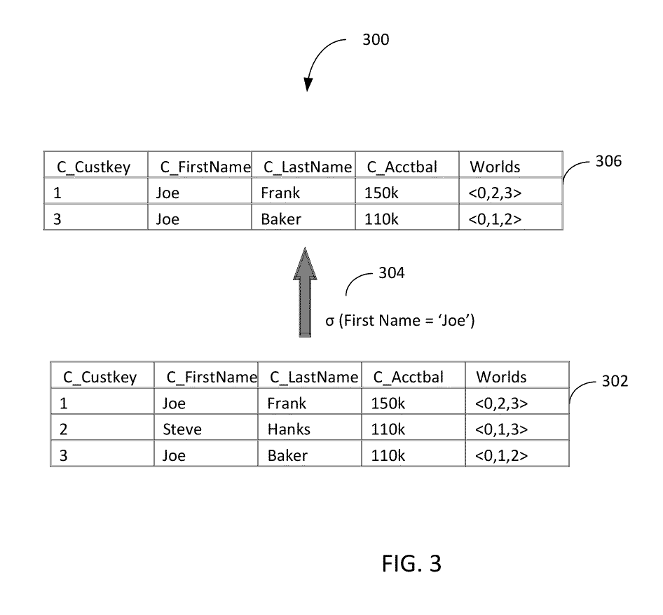

Thus, it is possible to add annotations to tuples produced as part of the intermediate results. FIG. 3 illustrates this with an example 300. FIG. 3 shows a filter 304 operating on a base table 302 (i.e., the filter finds all customers with first name “Joe”). The output of the filter 306 also has annotations (shown uncompressed) showing what worlds a particular result tuple belongs to. It will now be described the query evaluation for each operator.

Filter

The filter operator takes as input a table-set represented as an annotated table and a predicate. For each world, it is possible to find the tuples satisfying the predicate. The filter operator is executed by running the filter as a regular relational filter on the annotated table. For example, in FIG. 3, the filter applied on the annotated input table 302 produces the output table 306 shown. As, in this case, the evaluation does not use the annotations, the annotations can stay compressed.

For another example, consider a forbidden view V with n rows. Consider a filter that asks for a specific tuple in the forbidden view by specifying its primary key. There are n+1 worlds, one for every tuple in the view and one that contains all the rows. One straightforward evaluation of the filter might enumerate the n+1 worlds and run the filter on each. This takes time O(n²). Now, consider the evaluation above. The annotations add space linear in n since for any tuple the number of runs in the compressed representation is constant. Suppose the annotated table has index on the primary key. Then, running the filter on the annotated table would take time O(lg(n))—with the appropriate saving in time.

Project

A project operator in commercial database systems does not eliminate duplicates. It merely drops some columns for each input tuple. Similar to filter, an evaluation of projection is like standard projection except it is possible also to propagate the annotations unmodified. It will be appreciated that this evaluation yields the desired result.

CrossProduct

Given two tables R and S, the cross-product returns the table {(r,s):rεR, sεS}. It is possible to consider the cross-product operation when each of R and S is a table-set, represented as annotations in R and S. The space of all result tuples is still the original cross product. What remains to be determined is the subset of the cross product that pertains to any single world. In one embodiment, it may be observed that a tuple-pair (r, s) is present in exactly the worlds that contain r and s. Thus, it may be desirable to find the set {(r, s, r.Worlds∩s.Worlds): rεR; sεS}. In one embodiment, it is possible to: (1) run the cross-product as is and (2) add an annotation to every result that is the intersection of the base tuples' annotations.

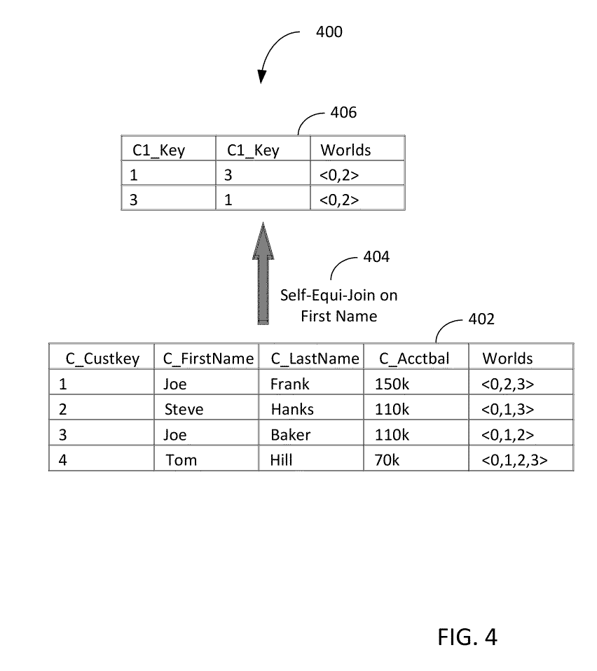

A join is equivalent to a cross-product followed by a filter. Suppose there is a e-join with the filter predicate θ. It follows from the cross-product and filter evaluations described above that it is possible to evaluate the join by running the original join over R and S and compute the annotation for every result pair as the intersection of the base tuples' annotations. It should be noted that the intersection of two run-length compressed sets can be computed by merging their runs without decompressing either of the sets. The output of the merge may then return the compressed form of the set. FIG. 4 illustrates a selfjoin on customer first name for the data in the example above. The benefits of this join evaluation are similar to the benefits for the filter operator.

Consider the forbidden view 402 in FIG. 4. Suppose it is desired to perform a self-join 404 on the key column of the view. As before, a straightforward algorithm would take time O(n²) whereas the evaluation of the present embodiment would take time O(n)—with the appropriate savings.

GroupbyAggregation

In one embodiment, the input to the groupby operator is a table-set given as an annotated table. Thus, it is possible to compute the result of the groupby for each world in the table-set as follows:

(1) convert the annotated table to first normal form to obtain a list of (tuple, world-id) pairs, where world-id is an identifier for a world;

(2) modify the original groupby operation to add the world-id column to the grouping columns and run the groupby and

(3) fold the results back into the form of an annotated table representing the result.

By way of illustration, consider the table in FIGS. 2A and 2B. Suppose it is desired to group by the customer first name and compute the number of rows per group, e.g., such as:

Select C_FirstName, Count(*)
From Customer
Group by C_FirstName

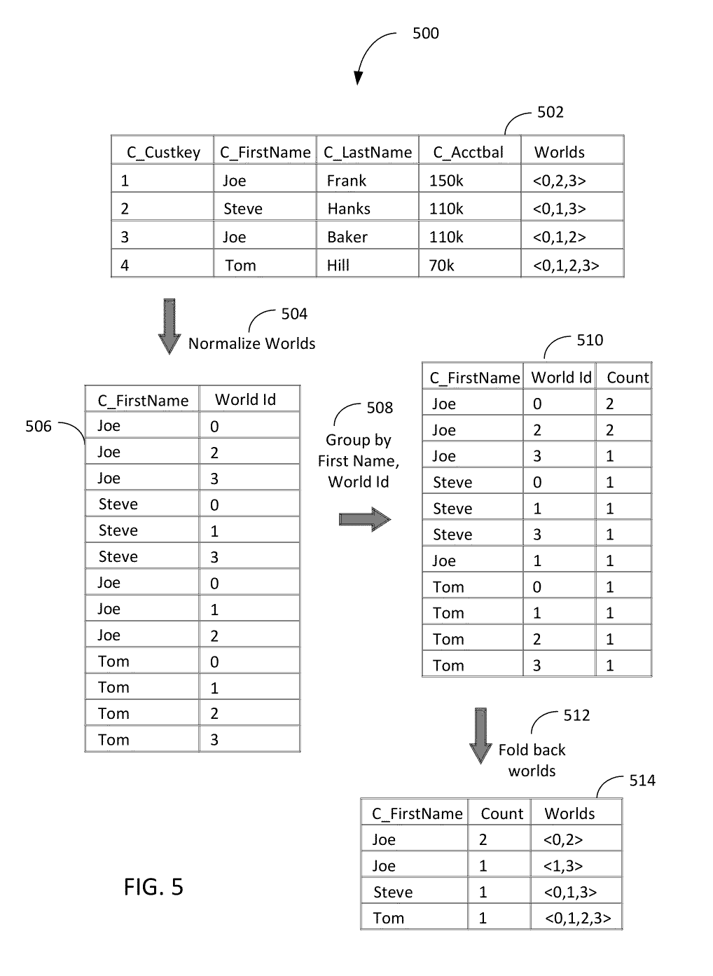

FIG. 5 illustrates the embodiment 500 as described above. Starting with annotated table 502, a normalization step 504 is performed to create (tuple, world-id) pairs 506. Modified groupby operation 508 is applied to produce table 510. Folding operation 512 back with respect to worlds produces annotated table 514.

In this embodiment, one issue is that the size of the first normal form table may be really large—e.g., the size of the first normal form table may be O(n²). Thus, it is possible to develop one evaluation technique that does not decompress the input tuple annotations. In one embodiment, it may be possible to consider a groupby operator with no aggregation—which may be construed as a duplicate eliminating projection. The input may be a table-set given as an annotated table. In this case, the evaluation proceeds such that a group appears in a world if any of the tuples in that group is present—e.g., by grouping the input table by the grouping columns. For each group, it is possible to compute the union of all tuple annotations. The union represents the annotation for the group.

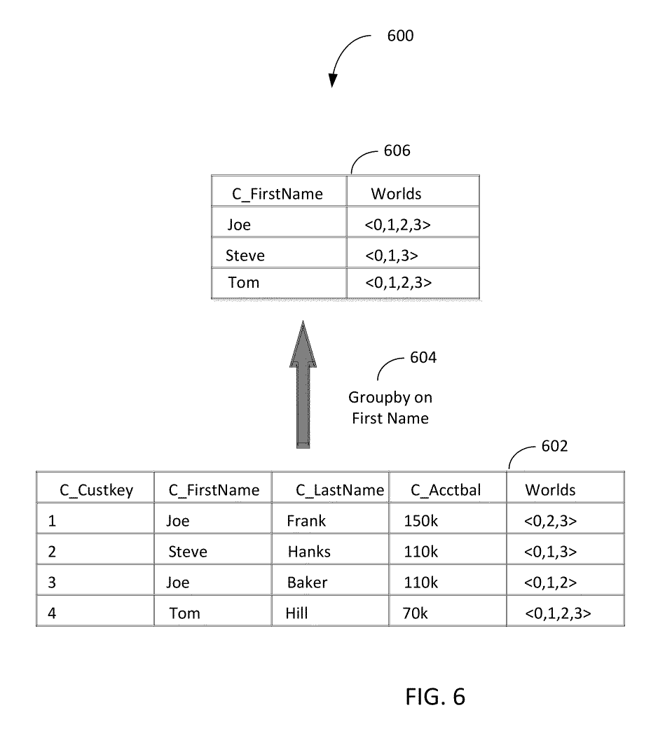

FIG. 6 shows an illustrative example (where the annotations are shown as uncompressed). Table 602 is operated on by Groupby on First Name operator 604, to produce annotated table 606. In SQL terms, the operation:

Select C_FirstName
From Customer
Group By C_FirstName

is transformed to:

Select C_FirstName, Union(Customer.Worlds)
From Customer
Group By C_FirstName.

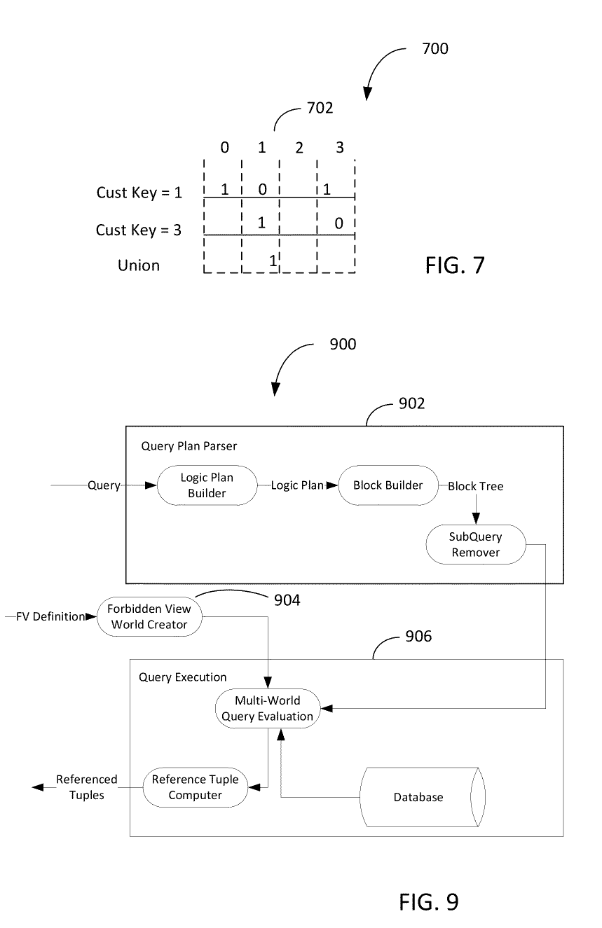

It will now be described how the union operation may be performed efficiently upon a collection of compressed annotations. For this embodiment, consider the vector representations of the annotations. Then, computing the union of all sets may be performed by computing for each dimension, a bitwise Or of all corresponding bits. It is possible then to make a sweep concurrently over all the tuple annotations in a given group from the smallest to the largest dimension. Whenever a run boundary is encountered, the result of the Or computation potentially changes and so may be recomputed. FIG. 7 illustrates the above embodiment for the two records in FIG. 2A that share the same first name. It is possible to implement the above idea by recomputing the bitwise Or at each run boundary.

However, in another embodiment, it is possible to improve the results as follows. Suppose the number of 1s is tracked among all the currently overlapping runs. Then, at each run boundary, it is possible to modify the number of 1s by examining the previous and current bits. Then, computing the bitwise Or using the number of 1s may be performed with much reduced processing. Since the result of the union may be being computed in dimension order, it is possible to maintain the output in a compressed form. Now, suppose that it is desired to perform the union of a set of compressed annotations, where the total number of runs over all annotations is N. Then, the above technique may return the union in compressed form in time O(N*lg(N)).

It will now be disclosed how to extend the groupby operator with aggregation; and, in particular, a single Sum aggregation. As before, the annotation may be represented by a Boolean vector that indicates for a given world and a given tuple whether the tuple is present in the world. In this embodiment, it is possible to modify the Boolean vector to replace the bit 0 with the value 0 and the bit 1 with the value from the tuple that is to be aggregated. It should be noted that the above step can be performed on the compressed annotation directly to yield a compressed vector.

Then, it is possible to aggregate vectors corresponding to all tuples in a group—resulting in an aggregate vector for each group. The aggregate vector represents the aggregation for different worlds which need not be equal. For each distinct value of the aggregation, it is possible to generate an output tuple. The annotation of the output tuple may thus indicate the worlds yielding the corresponding aggregate. The above approach may be extended to other SQL aggregate functions (namely count, min, max) and multiple aggregations.

Consider the table in FIG. 2B. Suppose an input query such as:

Select Sum(C_AcctBal), Count(*)
From Customer

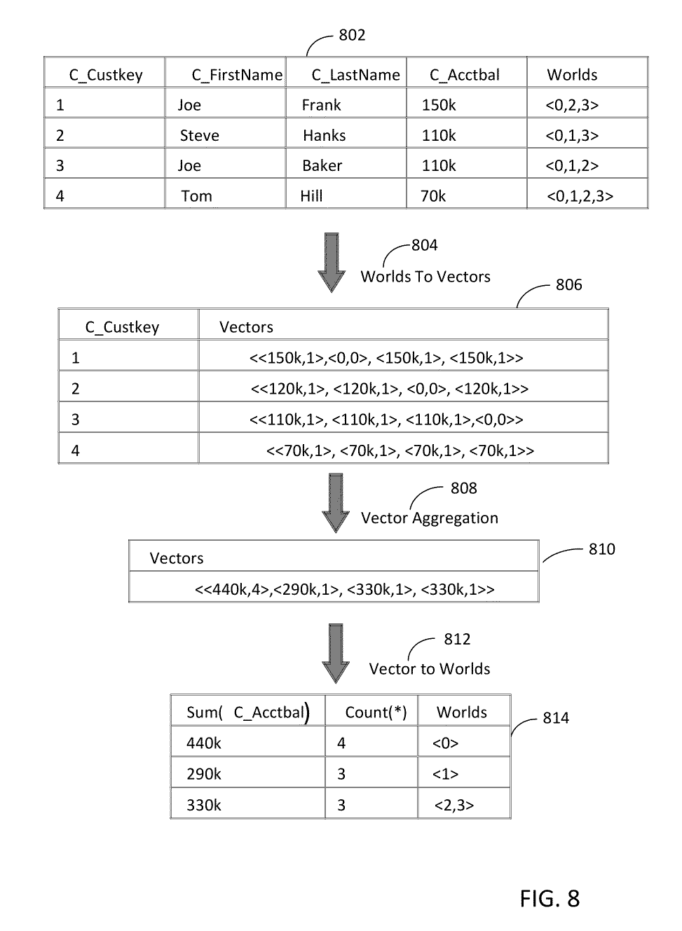

FIG. 8 illustrates the above technique for computing the result of groupby. Starting with table 802, worlds-to-vectors operation 804 is applied to produce table 806. Vector aggregation operation 808 is further applied to produce table 810. Vector-to-worlds operation 812 produces table 814.

The aggregation may be implemented analogously to the set union operation described above. Instead of a bitwise Or, it is possible to compute a Sum. Similar to a bitwise Or, a new value of the summation may be computed when a run boundary is encounter using the old summation, the previous and current run values. Suppose that it is desired to compute any of the following aggregates—sum, count, min, max—over an input table-set where the total number of runs over all annotations is N. The above groupby evaluation algorithm runs in time O(N lg(N)). Similar to filter and join, this query evaluation technique above may yield benefits over the basic implementation of the groupby operator.

Consider the forbidden view as above. Further, suppose that the input groupby query is:

select count(*) from V.

The result of the groupby query may be computed using the above technique in time O(n*lg(n)).

Set Difference

The standard set difference operator takes as input two tables R and S with the same schema and returns all rows in R that are not present in S. In this embodiment, it is possible to design an evaluation of the operator when R and S are table-sets. As before, the table-sets may be provided as annotated tables. In this case, it is possible that a tuple in R may be returned as a part of the output if there is at least one world where it is present only in R. Accordingly, it is possible to break the result into two parts:

(1) Find tuples in R that are not present in S (i.e., standard set difference). For these tuples, return the annotation of t in R as the result annotation.

(2) For tuples in R and S, compute the difference between the respective annotations. If the difference is non-empty, the tuple is returned with the difference as its annotation. As with set intersection, set difference can also be computed directly on the compressed sets to return the difference in compressed form.

Top-k

It should be noted that the min aggregation is a special case of Top-k where k=1. Thus, this embodiment for computing the Top-k on a table-set is similar to computing min. It is possible to make a sweep concurrently over all the tuple annotations maintaining the Top-k for the worlds seen so far. If it is desired to compute the Top-k over an input table-set where the total number of runs over all annotations is N, then above evaluation embodiment runs in time O(k* N lg(N)).

Subquery

Subqueries are constructs of SQL that are widely used. As described above, one present embodiment of a query evaluation may be based on the algebraic representation of a query. In another embodiment, it is possible to derive the algebraic representation using a query optimizer that converts a SQL string into an execution plan. Since subqueries are potentially expensive, the query optimizer may have rules for decorrelating subqueries in order to eliminate them from the plan. Alternatively, the rules may be applied in a cost-based manner so there is a possibility that the subquery may not be decorrelated.

In one embodiment, if a subquery is encountered in the execution plan, it may be explicitly decorrelate it. It is possible to use standard decorrelation techniques as, e.g., is illustrate through the following example.

Consider the following query that finds customers who have made expensive orders.

```
Select C_FirstName
From Customer
Where Exists( Select O_OrderKey
    From Order
    Where C_CustKey = O_CustKey
    and O_TotalPrice > 10000)
```

The above subquery is equivalent to running the following batch where no individual statement has a subquery.

```
Create View Outer(C_FirstName, C_CustKey) as
    (Select C_FirstName, C_CustKey
    From Customer)
Create View Inner(O_CustKey, C_CustKey) as
    (Select O_CustKey, C_CustKey
    From Order, Outer
    Where O_OrderKey = Outer.C_CustKey
        and O_TotalPrice > 10000)
Select C_CustKey
From Inner, Outer
Where Outer.C_CustKey = Inner.C_CustKey
```

Once such selections have been accomplished, the “References” operator continues to consume the result of the query evaluation on multiple worlds and finds all tuples in the forbidden view referenced. Consider a tuple t in the forbidden view. Suppose that the world associated with t, D−t, is W and the full database is D. A tuple t is “referenced” if some output tuple is present in world W but not present in world D or vice versa.

In one embodiment, it is possible to: (1) find all output records that contain the world corresponding to D; (2) intersect all their annotations and call the result S1; (3) find all output records that do not contain the world D; (3) take the union of all their annotations and call the result S2. The result then is the complement of S1-S2.

Implementation

For one possible implementation embodiment, References operator may be implemented as a client-side tool. This may be desirable as auditing is typically a client operation. FIG. 9 shows one possible architecture 900 of a present system. A query may be received by query plan parser 902 as, e.g., a SQL query. The query is first parsed using the query optimizer to obtain a physical plan. Although the above description was based on query evaluation in terms of operators, one implementation embodiment may be based on blocks that span multiple operators. For example, it is possible to collapse a sequence of filter, project and join operations into a single select-project-join block.

In order to detect the blocks from the physical plan, it is possible to convert the plan into a logical form that is then converted into a tree of blocks. As shown in FIG. 9, a query could be analyzed by a logic plan builder, producing a logic plan. The logic plan may be passed to a block builder to form a block tree. A query optimizer may decorrelate subqueries in a cost-based manner. However, if the final physical plan returned does contain a subquery, it is possible to eliminate the subquery with Subquery Remove, as shown in FIG. 9.

Query Execution module 906 may take as input the forbidden view definition to induce a world-set which is used along with the block tree to run the multi-world query evaluation algorithm. The final result of the References operation is then computed using the result of the query over all worlds. In one implementation, this system may be architected to use the .Net extensions provided by Microsoft SQL Server® system. It is also possible to encapsulate set and vector operations as SQL CLR user-defined functions. In this fashion, most of the references operator logic may execute in the server. The client logic mostly issues queries to the server. This may allow the system to scale the implementation with data size. In this embodiment, the system may support arbitrary SQL.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

1. A method for annotating data within a database D, the steps of said method comprising:
identifying a set of sensitive data within database D;
creating a forbidden view, V, from said a set of sensitive data;
creating a world set associated with each sensitive data from said forbidden view; and
storing an annotation of said world set created for each given sensitive data.

2. The method of claim 1 wherein said step of creating a world set further comprises:
computing a world set, W, as {D−t: tεV}∪{D}, for each sensitive data, t, within said database, D.

3. The method of claim 2 wherein said step of storing an annotation further comprises:
creating a field for each sensitive data, t, as a tuple annotation.

4. The method of claim 3 wherein said step of creating a field further comprises:
storing W in said field as a tuple annotation for each sensitive data, t.

5. The method of claim 4 wherein said method of annotating data within a database D further comprises the step of:
compressing the tuple annotation for each sensitive data, t.

6. The method of claim 5 wherein said step of compressing the tuple annotation further comprises the step of:
compressing the tuple annotation with run-length encoding.

7. The method of claim 6 wherein said step of compressing the tuple annotation with run-length encoding further comprises:
creating annotations as a set of Boolean vectors; and
compressing said Boolean vectors with run-length encoding.

8. A method for evaluating queries into a database, wherein said database comprises a forbidden view and annotated data, said annotated data comprising annotations based upon a world set induced by said forbidden view, the steps of said method comprising:
identifying an incoming query into the database;
breaking down said incoming query into a set of operators;
modifying each said operator to operator on said annotated data; and
producing a resulting annotation from each said modified operator when said modified operator is executed upon said database.

9. The method of claim 8 wherein said operator is one of a group, said group comprises: filter, project, cross-product, groupby, groupby-aggregation, set difference, and top-k.

10. The method of claim 9 wherein said operator is a filter and said step of modifying each said operator further comprises:
executing said filter operator on said annotated data.

11. The method of claim 9 wherein said operator is a project and said step of modifying each said operator further comprises:
executing said project operator on said annotated data.

12. The method of claim 9 wherein said operator is a cross-product and said step of modifying each said operator further comprises:
executing said cross-product operator on said annotated data; and
adding an resulting annotation to said database from said step of executing said cross-product operator wherein said resulting annotation comprising an intersection of the annotations of said annotated data.

13. The method of claim 9 wherein said operator is a groupby and said step of modifying each said operator further comprises:
converting said annotated data to a first normal form;
modifying said groupby operator to add an intermediate annotated data;
executing said groupby operator upon said intermediate annotating data; and
folding the results of the groupby operator execution back into the form of said annotated data.

14. The method of claim 13 wherein said annotations of said annotated data comprises Boolean vectors and further wherein said groupby operator aggregates said vectors when executing upon said annotated data.

15. The method of claim 9 wherein said operator is a set difference and said step of modifying each said operator further comprises:
executing said set difference operator on said annotated data to returning the annotations of resulting tuples; and
computing the difference between respective annotations in annotations returning from said step of executing said set difference operator.

16. The method of claim 8 wherein said method further comprises the step of:
decorrelating subqueries within said incoming query.

17. A method for auditing queries, said queries accessing data within a database, the steps of said method comprising:
identifying a set of sensitive data within a database;
for each sensitive data, determining an annotation, said annotation representing a set of worlds to which said sensitive data belongs;
determining if a query references said set of sensitive data by referencing the annotations propagated by said query; and
reporting a query that references said set of sensitive data.

18. The method of claim 17 wherein said step of identifying sensitive data further comprises creating a forbidden view of the database.

19. The method of claim 18 wherein said forbidden view induces said annotations representing said set of worlds.

20. The method of claim 19 wherein the step of determining if a query references said set of sensitive data further comprises the steps of:
modifying said query to execute upon said annotations; and
producing a resulting set of annotations based upon the modified query.
